(19) United States
(12) Patent Application Publication
(10) Pub. No.: US 2022/0282164 A1
(43) Pub. Date: Sep. 8, 2022

(54) SINGLE AND MULTIPLE TURBULENT/FAST FLUIDIZED BED REACTORS IN NCC PROCESS FOR MAXIMIZING AROMATICS PRODUCTION

(71) Applicant: SABIC GLOBAL TECHNOLOGIES B.V., BERGEN OP ZOOM (NL)

(72) Inventor: Mayank KASHYAP, Sugar Land, TX (US)

(21) Appl. No.: 17/632,579

(22) PCT Filed: Jul. 21, 2020
(86) PCT No.: PCT/IB2020/056850

§ 371 Date: Feb. 3, 2022

Related U.S. Application Data
(60) Provisional application No. 62/883,073, filed on Aug. 5, 2019.

(51) Int. Cl. C10G 11/18; B01J 8/18; B01J 8/28; B01J 8/00; B01J 4/00

(52) U.S. Cl. CPC C10G 11/18; B01J 8/1827; B01J 8/1863; B01J 8/28; B01J 8/005; B01J 4/004; B01J 2208/00752; B01J 2208/00761; B01J 2204/002; C10G 2300/1044; C10G 2400/30

(57) ABSTRACT

Systems and methods for producing aromatics are disclosed. A feed stream comprising naphtha is flowed into a reaction unit comprising a fast fluidized bed reactor coupled to and in fluid communication with a riser reactor. The fast fluidized bed reactor is adapted to enable backmixing therein to maximize the production of aromatics. The effluent from the fast fluidized bed reactor is further flowed to the riser reactor. The lift gas, which can comprise nitrogen, methane, flue gas, or combinations thereof, is injected in the reaction unit via a sparger. The effluent of the riser reactor is separated in a product separation unit to produce a product stream comprising light olefins and spent catalyst. The spent catalyst is further stripped by a stripping gas comprising methane, nitrogen, flue gas, or combinations thereof. The stripped spent catalyst is regenerated to produce regenerated catalyst, which is subsequently flowed to the fast fluidized bed reactor.

### CROSS REFERENCE TO RELATED APPLICATIONS

This application claims the benefit of priority of U.S. Provisional Patent Application No. 62/883,073, filed Aug. 5, 2019, which is hereby incorporated by reference in its entirety.

### FIELD OF INVENTION

The present invention generally relates to a process for producing aromatics. More specifically, the present invention relates to an integrated process that includes catalytically cracking naphtha in a fast fluidized bed that is coupled to a riser reactor to produce aromatics.

### BACKGROUND OF THE INVENTION

BTX (benzene, toluene, and xylene) are a group aromatics that are used in many different areas of the chemical industry, especially the plastic and polymer sectors. For instance, benzene is a precursor for producing polystyrene, phenolic resins, polycarbonate, and nylon. Toluene is used for producing polyurethane and as a gasoline component. Xylene is feedstock for producing polyester fibers and phthalic anhydride. In the petrochemical industry, benzene, toluene, and xylene are conventionally produced by catalytic reforming of naphtha.

Over the last few decades, the demand for aromatics, especially BTX, has been consistently increasing. One of the conventional methods of producing BTX includes steam cracking hydrocarbon feeds such as naphtha. However, the overall efficiency for this conventional method is relatively low. Besides aromatics, other products including olefins, which compete with aromatics in the process, are also produced. Furthermore, a large amount of hydrocarbons in the effluent are recycled to the steam cracking unit. As hydrocarbons have to be hydrogenated before they are recycled back to the steam cracking unit, the large amount of hydrocarbons for recycling can demand a large amount of hydrogen and energy in the hydrogenation process, resulting in high production cost.

Another conventional method for producing aromatics (e.g., BTX) includes catalytic cracking of naphtha in a fluidized bed. However, these conventional fluidized bed reactors are generally operated with low average solid volume fraction and low gas-solids contact efficiency due to the limitation of superficial gas velocities in the fluidized bed. Thus, the products of the conventional methods often include a high methane content produced from thermal cracking of hydrocarbons, resulting in increased production cost for aromatics.

Overall, while methods of producing aromatics exist, the need for improvements in this field persists in light of at least the aforementioned drawbacks for the methods.

### BRIEF SUMMARY OF THE INVENTION

A solution to at least some of the above-mentioned problems associated with the production process for aromatics, including BTX, using naphtha has been discovered. The solution resides in a method of producing aromatics that includes using a fast fluidized bed reactor coupled to and in fluid communication with a riser reactor to catalytically crack naphtha. The superficial gas velocity in the riser reactor is significantly higher than with the conventional methods. This can be beneficial for at least providing high solid volumetric fraction in the riser reactor, thereby reducing the occurrence of thermal cracking of the naphtha. Notably, the fluidized bed reactor used in this method does not require any internal structure to limit backmixing, resulting in sufficient mixing in the fluidized bed reactor and higher overall yield of aromatics. Additionally, the lift gas used in the fast fluidized bed reactor and the riser reactor does not contain steam. Thus, zeolite based catalyst, which has higher efficiency than non-zeolite based catalyst, can be used as it will not undergo de-alumination by steam. Therefore, the method of the present invention provides a technical solution to at least some of the problems associated with the currently available methods for producing aromatics mentioned above.

Embodiments of the invention include a method of producing aromatics. The method comprises contacting, in a fast fluidized bed reactor, naphtha with catalyst particles of a fast-fluidized bed having a superficial gas velocity (SGV) in a range of 1 to 6.5 m/s and under first reaction conditions sufficient to produce a first product comprising one or more aromatics. The method further comprises flowing effluent of the fast fluidized bed reactor to a riser reactor, the effluent of the fast fluidized bed reactor comprising (1) unreacted hydrocarbons of the naphtha, (2) the first product, and (3) the catalyst particles. The method further comprises contacting, in the riser reactor, the unreacted hydrocarbons of the naphtha, the first product, and the catalyst particles under second reaction conditions sufficient to produce a second product comprising one or more aromatics.

Embodiments of the invention include a method of producing aromatics. The method comprises contacting, in a fast fluidized bed reactor, naphtha with catalyst particles of a fast-fluidized bed having a superficial gas velocity (SGV) in a range of 1 to 6.5 m/s and under first reaction conditions sufficient to produce a first product comprising one or more aromatics. The first reaction conditions comprise a temperature in a range of 670 to 730° C. The method further comprises flowing effluent of the fast fluidized bed reactor to a riser reactor. The effluent of the fast fluidized bed reactor comprises (1) unreacted hydrocarbons of the naphtha, (2) the first product, and (3) the catalyst particles. The method further still comprises contacting, in the riser reactor, the unreacted hydrocarbons of the naphtha, the first product, and at least some of the catalyst particles under second reaction conditions sufficient to produce a second product comprising one or more aromatics. The second reaction conditions comprise a temperature in a range of 640 to 720° C.

Embodiments of the invention include a reaction unit for producing aromatics. The reaction unit comprises a fast fluidized bed reactor. The fast fluidized bed reactor comprises a housing, a feed inlet adapted to receive hydrocarbon feed into the housing, a catalyst inlet adapted to receive catalyst particles that are capable of catalyzing cracking of the hydrocarbon feed to produce aromatics into the housing, a lift gas inlet adapted to receive a lift gas into the housing, and catalyst particles disposed in the housing. The fast fluidized bed reactor does not require any internal structure to limit backmixing in the fast fluidized bed reactor. The reaction unit further comprises a riser reactor disposed on top of the fast fluidized bed reactor. The riser reactor is in fluid communication with the fast fluidized bed reactor such that content from the fast fluidized bed reactor flows into the riser reactor.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The term “raffinate,” as the term is used in the specification and/or claims, means the rest of a product stream, from which a target component or components have been removed.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system for producing aromatics, according to embodiments of the invention; and

FIG. 2 shows a schematic flowchart of a method of producing aromatics, according to embodiments of the invention.

### DETAILED DESCRIPTION OF THE INVENTION

Currently, aromatics, including BTX, can be produced by steam cracking or catalytic cracking of naphtha. However, the overall conversion rate to aromatics for steam cracking naphtha is relatively low. Furthermore, the production costs for steam cracking naphtha is high, as steam cracking of naphtha produces a large amount of raffinate, which needs to be hydrogenated before it is recycled back to the steam cracking unit. Thus, the large amount of raffinate results in large demand for hydrogen and energy in the hydrogenation process. Conventional processes of catalytic cracking naphtha generally require relatively low superficial gas velocities and extremely high catalyst to oil ratio in the catalyst bed, which lead to challenges to maintaining pressure balance in the riser reactor. Furthermore, the conventional catalytic cracking of naphtha uses steam as lift gas, which prevents using zeolites based catalyst in the reactor, thereby reducing the aromatics production efficiency. The present invention provides a solution to at least some of these problems. The solution is premised on a method including catalytically cracking naphtha in a reaction unit that comprises a fast fluidized bed reactor coupled with a riser reactor. This method is capable of retaining a high solid volumetric fraction along with high superficial gas velocity in the reaction unit, thereby reducing the thermal cracking of naphtha and increasing yields of aromatics. Additionally, the fast fluidized bed reactor used in embodiments of the invention is adapted to enable the backmixing therein. Thus, the selectivity to aromatics is increased over conventional methods. Moreover, this method uses a lift gas that does not contain steam such that zeolite based catalyst can be used in the reaction unit, resulting in improved aromatics production efficiency. These and other non-limiting aspects of the present invention are discussed in further detail in the following sections.

### A. System for Catalytically Cracking Naphtha to Produce Aromatics

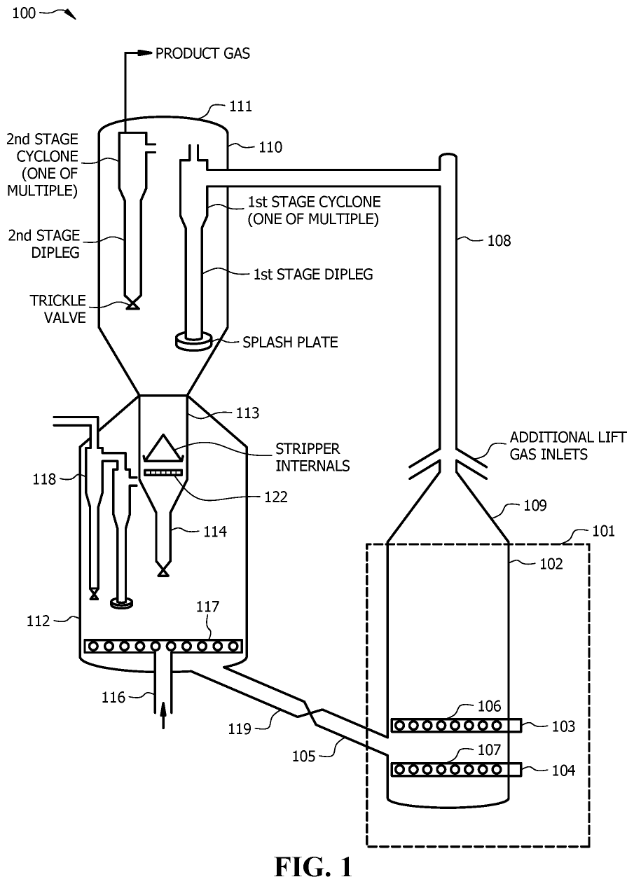

In embodiments of the invention, the reaction unit for producing aromatics via catalytic cracking of naphtha comprises one or more fast fluidized bed reactors, one or more riser reactors, a product separator, and a catalyst regeneration unit. In embodiments of the invention, a fast fluidized bed reactor can be characterized by the coexistence of dense phase region at the bottom and dilute phase region on the top, where particles are transported out of the bed and need to be replaced and/or recycled. With reference to FIG. 1, a schematic diagram is shown of reaction unit 100 that is configured to produce aromatics (e.g., benzene, toluene, and xylene) with improved production efficiency and yield, compared to conventional steam cracking or catalytic cracking processes. According to embodiments of the invention, reaction unit 100 may include fast fluidized bed reactor 101 comprising housing 102, feed inlet 103, lift gas inlet 104, and catalyst inlet 105.

In embodiments of the invention, housing 102 is made of steel, carbon steel, refractory, or combinations thereof. Housing 102 is adapted to hosting the catalytic cracking reaction of naphtha fed therein. According to embodiments of the invention, feed inlet 103 may be disposed at lower half of housing 102 and adapted to receive a feed stream therein. In embodiments of the invention, the feed stream includes naphtha. According to embodiments of the invention, feed inlet 103 is in fluid communication with feed sparger 106 disposed in lower half portion in housing 102. Feed sparger 106 is adapted to distribute naphtha received from feed inlet 103 in housing 102, according to embodiments of the invention. Feed sparger 106 may comprise a plurality of upwards nozzles and downwards nozzles for releasing naphtha in both directions.

In embodiments of the invention, lift gas inlet 104 is disposed at lower half of housing 102, but lower than feed sparger 106, where lift gas inlet 104 is adapted to receive a lift gas stream in housing 102. The lift gas stream may include nitrogen, methane, any inert gas, or combinations thereof. According to embodiments of the invention, lift gas inlet 104 may be in fluid communication with lift gas sparger 107 disposed in lower half portion in housing 102. According to embodiments of the invention, lift gas sparger 107 is disposed below feed sparger. 106. In embodiments of the invention, lift gas sparger 107 is adapted to distribute lift gas received from lift gas inlet 104 in housing 102 at a velocity sufficient to carry materials in housing 102 upwards. In embodiments of the invention, lift gas sparger 107 comprises a plurality of upwards nozzles and downwards nozzles for releasing the lift gas in both directions. In embodiments of the invention, catalyst inlet 105 is disposed on lower half of housing 102 above lift gas inlet 104. Catalyst inlet 105 may be adapted to receive catalyst particles into housing 102. Non-limiting examples for the catalyst particles may include zeolite.

According to embodiments of the invention, reaction unit 100 further comprises riser reactor 108 disposed on top of fast fluidized bed reactor 101. Riser reactor 108 may be adapted to further catalytically crack hydrocarbons flowed from fast fluidized bed reactor 101. In embodiments of the invention, riser reactor 108 has a smaller cross-sectional surface than that of fast fluidized bed reactor 101. In embodiments of the invention, a cross-sectional surface ratio of fast fluidized bed reactor 101 to riser reactor 108 is in a range of 2.5 to 20 and all ranges and values there between including ranges of 2.5 to 5.0, 5.0 to 7.5, 7.5 to 10.0, 10.0 to 12.5, 12.5 to 15.0, 15.0 to 17.5, and 17.5 to 20.0. In embodiments of the invention, fast fluidized bed reactor 101 and riser reactor 108 are in fluid communication via transition zone 109. The sectional surface area of transition zone 109 may gradually decrease from top surface of fast fluidized bed reactor 101 to bottom surface of riser reactor 108.

In embodiments of the invention, fast fluidized bed reactor 101 and riser reactor 108 both are substantially cylindrical. Transition zone 109 may be a flat-top cone shaped structure in fluid communication with fast fluidized bed reactor 101 and riser reactor 108. Fast fluidized bed reactor 101 may have an inner diameter in a range of 2.5 to 10 m and all ranges and values there between including ranges of 2.5 to 3.0 m, 3.0 to 3.5 m, 3.5 to 4.0 m, 4.0 to 4.5 m, 4.5 to 5.0 m, 5.0 to 5.5 m, 5.5 to 6.0 m, 6.0 to 6.5 m, 6.5 to 7.0 m, 7.0 to 7.5 m, 7.5 to 8.0 m, 8.0 to 8.5 m, 8.5 to 9.0 m, 9.0 to 9.5 m, and 9.5 to 10 m. Riser reactor 108 may have an inner diameter in a range of 1 to 2.5 m and all ranges and values there between including ranges of 1 to 1.1 m, 1.1 to 1.2 m, 1.2 to 1.3 m, 1.3 to 1.4 m, 1.4 to 1.5 m, 1.5 to 1.6 m, 1.6 to 1.7 m, 1.7 to 1.8 m, 1.8 to 1.9 m, 1.9 to 2.0 m, 2.0 to 2.1 m, 2.1 to 2.2 m, 2.2 to 2.3 m, 2.3 to 2.4 m, and 2.4 to 2.5 m. According to embodiments of the invention, lift gas sparger 107 in fast fluidized bed reactor 101 is further configured to release lift gas at a velocity sufficient to carry materials in riser reactor 108 upwards. In embodiments of the invention, riser reactor 108 comprises one or more additional lift gas inlets adapted to provide additional lift gas therein to carry the materials upwards in riser reactor 108. The one or more additional lift gas inlet may be disposed at the bottom of riser reactor 108.

In embodiments of the invention, riser reactor 108 may be in fluid communication with separation unit 110 such that effluent from riser reactor 108 flows from riser reactor 108 to separation unit 110. Effluent from riser reactor 108 may include unreacted naphtha, aromatics, lift gas, spent catalyst particles, any other by-products, or combinations thereof. According to embodiments of the invention, separation unit 110 is adapted to separate effluent from riser reactor 108 into a product gas stream and a spent catalyst stream. In embodiments of the invention, the product gas stream includes aromatics, unreacted naphtha, light olefins, lift gas, by-products, or combinations thereof. The aromatics may include benzene, toluene, and xylene. The spent catalyst stream may include spent catalyst particles, hydrocarbons absorbed in the spent catalyst particles, lift gas, or combinations thereof.

According to embodiments of the invention, separation unit 110 comprises separation unit housing 111 and one or more cyclones adapted to separate the effluent from riser reactor 108 into spent catalyst particles and product gas. In embodiments of the invention, each cyclone in separation unit 110 is single- or multiple-stage cyclone. Each cyclone may be in fluid communication with a dipleg. The dipleg is adapted to transfer catalyst particles from the cyclone to the dense bed close to the bottom of separation unit 110 (separation unit housing 111). In embodiments of the invention, the dipleg for each cyclone is further in fluid communication with a splash plate and/or a trickle valve. The splash plate and/or trickle valve may be adapted to avoid bypassing of gas up the dipleg of a cyclone.

In embodiments of the invention, a bottom end of separation unit 110 may be in fluid communication with catalyst regeneration unit 112 such that spent catalyst stream flows from separation unit 110 to catalyst regeneration unit 112. In embodiments of the invention, catalyst regeneration unit 112 is adapted to further strip hydrocarbons absorbed on the spent catalyst and regenerate the spent catalyst after the stripping process. Catalyst regeneration unit 112 may be further adapted to separate flue gas from the catalyst.

According to embodiments of the invention, regeneration unit 112 comprises stripper 113 configured to strip hydrocarbons absorbed on the spent catalyst. Stripper 113 may comprise a stripping gas sparger 122 configured to release stripping gas for contacting the spent catalyst. Non-limiting examples for the stripping gas can include nitrogen, methane, flue gas, and combinations thereof. Stripper 113 may further comprise stripper internals configured to enhance counter-current contacting between down-flowing stream (emulsion phase) and up-flowing bubbles stream in strippers 113. The stripper internals may include disk structured internals, chevron structured internals, packing internals, subway grating internals, or combinations thereof. Stripper 113 may further comprise standpipe 114 adapted to transfer catalyst particles from stripper 113 to regeneration unit 112 and a slide valve adapted to control flow rate of catalyst particles from stripper 113 to regeneration unit 112. In embodiments of the invention, catalyst regeneration unit 112 further comprises air inlet 116 in fluid communication with air sparger 117 that is disposed in catalyst regeneration unit 112 such that air is supplied into catalyst regeneration unit 112 through air inlet 116 and air sparger 117. According to embodiments of the invention, catalyst regeneration unit 112 further comprises one or more cyclones (e.g., cyclone 118) adapted to separate flue gas from the catalyst. The flue gas may be produced during the catalyst regeneration process. According to embodiments of the invention, catalyst regeneration unit 112 comprises catalyst outlet 119 in fluid communication with catalyst inlet 105 of fast fluidized bed reactor 101 such that regenerated catalyst flows from catalyst regeneration unit 112 to fast fluidized bed reactor 101.

According to embodiments of the invention, a catalytic cracking system may include two or more fast fluidized bed reactors 101 in fluid communication with one catalyst regeneration unit (catalyst regeneration unit 112) such that regenerated catalyst flows from catalyst regeneration unit 112 to each of the two or more fast fluidized bed reactors 101. The catalytic cracking system may include two or more riser reactors 108 disposed on top of each of the two or more fast fluidized bed reactors 101. In embodiments of the invention, each of the two or more riser reactors 108 is in fluid communication with one product separation unit (separation unit 110) such that effluent of each of the two or more riser reactors 108 flows to separation unit 110.

### B. Method of Producing Aromatics

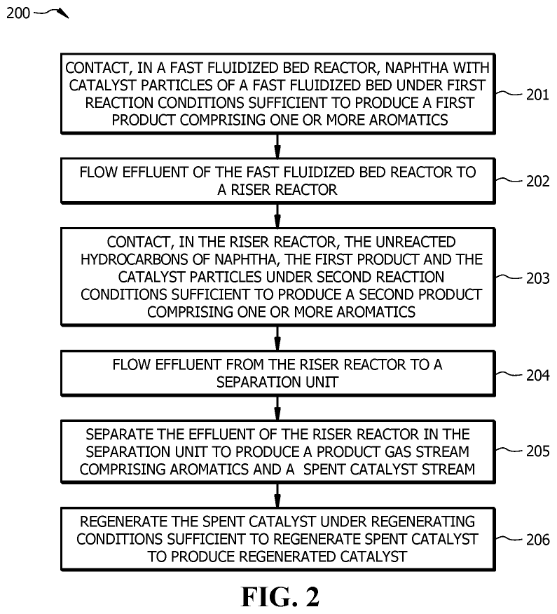

Methods of producing aromatics via catalytic cracking of naphtha have been discovered. The methods may be capable of increasing solid volumetric fraction in the reaction unit, enabling backmixing during the catalytic cracking process, and minimizing occurrence of thermal cracking compared to conventional methods of catalytic cracking. Therefore, the methods may be able to significantly improve production efficiency of aromatics via catalytic cracking compared to conventional methods. As shown in FIG. 2, embodiments of the invention include method 200 for producing aromatics including BTX. Method 200 may be implemented by reaction unit 100, as shown in FIG. 1.

According to embodiments of the invention, as shown in block 201, method 200 may include contacting, in fast fluidized bed reactor 101, naphtha with catalyst particles of a fast fluidized bed under first reaction conditions sufficient to produce a first product comprising one or more aromatics, as shown in block 201. In embodiments of the invention, the contacting at block 201 includes injecting, into fast fluidized bed reactor 101, the lift gas from lift gas sparger 107 and naphtha from feed sparger 106 such that the catalyst particles and the naphtha make contact with each other and the materials in fast fluidized bed reactor 101 move upwards. In embodiments of the invention, the naphtha at the contacting step of block 201 comprises hydrocarbons with an final boiling point lower than 350° C. In embodiments of the invention, first reaction conditions at block 201 may include a superficial gas velocity (SGV) in a range of 1 to 6.5 m/s and all ranges and values there between including ranges of 1 to 1.5 m/s, 1.5 to 2.0 m/s, 2.0 to 2.5 m/s, 2.5 to 3.0 m/s, 3.0 to 3.5 m/s, 3.5 to 4.0 m/s, 4.0 to 4.5 m/s, 4.5 to 5.0 m/s, 5.0 to 5.5 m/s, 5.5 to 6.0 m/s, and 6.0 to 6.5 m/s. First reaction conditions may further include a reaction temperature in fast fluidized bed reactor 101 in a range of 690 to 710° C. and all ranges and values there between including 690 to 692° C., 692 to 694° C., 694 to 696° C., 696 to 698° C., 698 to 700° C., 700 to 702° C., 702 to 704° C., 704 to 706° C., 706 to 708° C., and 708 to 710° C. First reaction conditions at block 201 may further include a reaction pressure of 1 to 3 bar and all ranges and values there between including ranges of 1 to 1.5 bar, 1.5 to 2.0 bar, 2.0 to 2.5 bar, and 2.5 to 3.0 bar. First reaction conditions at block 201 may further include an average residence time in fast fluidized bed reactor 101 of 1 to 15 s and all ranges and values there between including ranges of 1 to 3 s, 3 to 6 s, 6 to 9 s, 9 to 12 s, and 12 to 15 s. First reaction conditions may further include weight hourly space velocity (WHSV) in a range of 0.3 to 3 hr⁻¹ and all ranges and values there between including ranges of 0.3 to 0.6 hr⁻¹, 0.6 to 0.9 hr⁻¹, 0.9 to 1.2 hr⁻¹ 1.2 to 1.5 hr⁻¹, 1.5 to 1.8 hr⁻¹, 1.8 to 2.1 hr⁻¹, 2.1 to 2.4 hr⁻¹2.4 to 2.7 hr⁻¹, and 2.7 to 3.0 hr⁻¹. According to embodiments of the invention, at block 201, a solid volumetric fraction (SVF) in fast fluidized bed reactor 101 may be in a range of 0.12 to 0.35 and all ranges and values there between including ranges of 0.12 to 0.15, 0.15 to 0.18, 0.18 to 0.21, 0.21 to 0.24, 0.24 to 0.27, 0.27 to 0.30, 0.30 to 0.33, and 0.33 to 0.35. According to embodiments of the invention, the catalyst of fast fluidized bed reactor 101 includes zeolite. In embodiments of the invention, the catalyst has a particle size of 75 to 120 μm and all ranges and values there between including ranges of 75 to 78 μm, 78 to 81 μm, 81 to 84 μm, 84 to 87 μm, 87 to 90 μm, 90 to 93 μm, 93 to 96 μm, 96 to 99 μm, 99 to 102 μm, 102 to 105 μm, 105 to 108 μm, 108 to 111 μm, 111 to 114 μm, 114 to 117 μm, and 117 to 120 μm. The catalyst may have a particle density of about 1200 kg/m³.

According to embodiments of the invention, at block 201, the lift gas and the naphtha are flowed into fast fluidized bed reactor at a volumetric ratio of 0.4 to 0.8 and all ranges and values there between including ranges of 0.4 to 0.5, 0.5 to 0.6, 0.6 to 0.7, and 0.7 to 0.8. The fast fluidized bed may comprise a catalyst to oil ratio of 10 to 50 and all ranges and values here between including ranges of 10 to 15, 15 to 20, 20 to 25, 25 to 30, 30 to 35, 35 to 40, 40 to 45, and 45 to 50. In embodiments of the invention, at block 201, contacting step includes sufficient back mixing in the fast fluidized bed for maximizing aromatics production.

According to embodiments of the invention, method 200 further includes flowing effluent of fast fluidized bed reactor 101 to riser reactor 108, as shown in block 202. In embodiments of the invention, the effluent of fast fluidized bed reactor 101 comprises (1) unreacted hydrocarbons of the naphtha, (2) the first product, and (3) the catalyst particles. The effluent of fast fluidized bed reactor 101 may further include lift gas. In embodiments of the invention, the flowing at block 202 is propelled by the lift gas. Non-limiting examples of the lift gas may include nitrogen, methane, any inert gas, steam, or combinations thereof.

According to embodiments of the invention, as shown in block 203, method 200 further includes contacting in riser reactor 108, the unreacted hydrocarbons of naphtha, the first product and the catalyst particles under second reaction conditions sufficient to produce a second product comprising one or more aromatics. In embodiments of the invention, the second reaction conditions at block 203 include a reaction temperature in riser reactor 108 in a range of 670 to 700° C. and all ranges and values there between including ranges of 670 to 673° C., 673 to 676° C., 676 to 679° C., 679 to 682° C., 682 to 685° C., 685 to 688° C., 688 to 691° C., 691 to 694° C., 694 to 697° C., and 697 to 700° C. The second reaction conditions at block 203 may further include a reaction pressure of 1 to 3 bar and all ranges and values there between including ranges of 1 to 1.5 bar, 1.5 to 2.0 bar, 2.0 to 2.5 bar, and 2.5 to 3.0 bar. The second reaction conditions at block 203 may further include a superficial gas velocity of 12 to 21 m/s in riser reactor 108 and all ranges and values there between including ranges of 12 to 13 m/s, 13 to 14 m/s, 14 to 15 m/s, 15 to 16 m/s, 16 to 17 m/s, 17 to 18 m/s, 18 to 19 m/s, 19 to 20 m/s, and 20 to 21 m/s. The second reaction conditions may further include a weight hourly space velocity in a range of 0.3 to 3 hr⁻¹ and all ranges and values there between including ranges of 0.3 to 0.6 hr⁻¹, 0.6 to 0.9 hr⁻¹, 0.9 to 1.2 hr⁻¹ 1.2 to 1.5 hr⁻¹, 1.5 to 1.8 hr⁻¹, 1.8 to 2.1 hr⁻¹, 2.1 to 2.4 hr⁻¹ 2.4 to 2.7 hr⁻¹, and 2.7 to 3.0 hr⁻¹. The second reaction conditions at block 203 may further still include an average residence time in riser reactor 108 in a range of 0.4 to 2 s and all ranges and values there between including ranges of 0.4 to 0.6 s, 0.6 to 0.8 s, 0.8 to 1.0 s, 1.0 to 1.2 s, 1.2 to 1.4 s, 1.4 to 1.6 s, 1.6 to 1.8 s, and 1.8 to 2.0 s. At block 203, a solid volumetric fraction in riser reactor 108 may be in a range of 0.02 to 0.08 and all ranges and values there between including ranges of 0.02 to 0.03, 0.03 to 0.04, 0.04 to 0.05, 0.05 to 0.06, 0.06 to 0.07, and 0.07 to 0.08. In embodiments of the invention, method 200 includes optionally flowing additional lift gas through additional lift gas inlet disposed at lower half of riser reactor 108 to provide more lifting force for materials in riser reactor 108.

According to embodiments of the invention, as shown in block 204, method 200 further includes flowing effluent from riser reactor 108 to separation unit 110. The effluent from riser reactor 108 may include unreacted hydrocarbons of naphtha, the first product, the second product, the spent catalyst particles, the lift gas, steam, or combinations thereof. As shown in block 205, method 200 may further comprise separating the effluent of riser reactor 108 in separation unit 110 to produce a product gas stream comprising aromatics and a spent catalyst stream comprising spent catalyst and flue gas. The separating at block 205 may include passing the effluent of riser reactor 108 through one or more cyclones of separation unit 110. In embodiments of the invention, the product gas stream comprises 13 to 33 wt. % aromatics.

In embodiments of the invention, the spent catalyst stream may be flowed to catalyst regeneration unit 112. The spent catalyst may be further stripped in stripper 113 by the stripping gas to remove hydrocarbons absorbed on spent catalyst particles. The stripping gas may include nitrogen, methane, flue gas, or combinations thereof. According to embodiments of the invention, as shown in block 206, method 200 further comprises regenerating spent catalyst under regenerating conditions sufficient to regenerate spent catalyst to produce regenerated catalyst. In embodiments of the invention, regeneration conditions may include a temperature in a range of 680 to 750° C. and all ranges and values there between including ranges of 680 to 690° C., 690 to 700° C., 700 to 710° C., 710 to 720° C., 720 to 730° C., 730 to 740° C., and 740 to 750° C. Flue gas generated during the regenerating step at block 206 may be further separated via one or more cyclones. Regenerated catalyst may be flowed to fast fluidized bed reactor 101. In embodiments of the invention, method 200 is capable of producing aromatics with a yield of BTX (benzene, toluene, xylene) greater than 30 wt. %.

Although embodiments of the present invention have been described with reference to blocks of FIG. 2, it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

As part of the disclosure of the present invention, a specific example is included below. The example is for illustrative purposes only and is not intended to limit the invention. Those of ordinary skill in the art will readily recognize parameters that can be changed or modified to yield essentially the same results.

### Example

### Aromatics Production in a Pilot Plant of a Fast Fluidized Bed Coupled with a Riser Reactor

A pilot plant of the reaction unit as described above was used to produce aromatics including BTX via catalytic cracking of naphtha. The reaction included a fast fluidized bed reactor (FFBR) coupled to a riser reactor. The fast fluidized bed reactor is adapted to enable the backmixing in the reaction unit. The naphtha used for the pilot plant experiment included 22-24 wt. % normal paraffin, 27-30 wt. % iso-paraffin, 32-35 wt. % naphthenic species, 11-13 wt. % aromatics, less than 0.5 wt. % olefins and less than 8 wt. % other components. The reaction conditions during the pilot plant experiment run included reaction temperature of 680° C., catalyst regeneration temperature of 700° C., a weight hourly space velocity of 1.9 hr⁻¹ and a catalyst load of 1500 g. The results of the yields for the product obtained from the pilot plant experiment are shown in Table. 1

The results show that high BTX yields of the order of 30% can be obtained in a reactor operated under conditions comprising short contact times, high solids volume fractions and high backmixing. Table 1 shows product streams obtained under above mentioned operating conditions, in a pilot plant campaign. The results in table 1 showed that high BTX yields can be obtained without compromising with light olefins yields.

TABLE 1
Yields of main products from catalytic cracking of naphtha

| | Dense Phase |
|---|---|
| | max Total Yield |
| CH4 | <10 |
| C2H4 | 12-14 |
| C2H4 + C3H6 | 23-27 |
| C2H4 + C3H6 + C4H8 | 30-33 |
| BTX | >30 |
| C2H4 + C3H6 + C4H8 + BTX | >60 |
| C3H6/C2H4 ratio | 0.70-0.95 |
| C2H4 + C3H6 + C4H8/BTX ratio | >0.9 |

In the context of the present invention, at least the following 18 embodiments are described. Embodiment 1 is a method of producing an aromatic. The method includes contacting, in a fast fluidized bed reactor, naphtha with catalyst particles of a fast-fluidized bed having a superficial gas velocity (SGV) in a range of 1 to 6.5 m/s and under first reaction conditions sufficient to produce a first product containing one or more aromatics. The method further includes flowing effluent of the fast fluidized bed reactor to a riser reactor, the effluent of the fast fluidized bed reactor containing (1) unreacted hydrocarbons of the naphtha, (2) the first product, and (3) the catalyst particles. The method still further includes contacting, in the riser reactor, the unreacted hydrocarbons of the naphtha, the first product, and the at least some of the catalyst particles under second reaction conditions sufficient to produce a second product containing one or more aromatics. Embodiment 2 is the method of embodiment 1, wherein the first reaction conditions include a reaction temperature in the fast fluidized bed reactor of 690 to 710° C. Embodiment 3 is the method of either of embodiments 1 or 2, wherein the first reaction conditions include a reaction pressure in the fast fluidized bed reactor of 1 to 3 bar. Embodiment 4 is the method of any of embodiments 1 to 3, wherein the first reaction conditions include an average residence time in the fast fluidized bed reactor of 1 to 15 s. Embodiment 5 is the method of any of embodiments 1 to 4, wherein the second reaction conditions include a reaction temperature in the riser reactor of 670 to 700° C. Embodiment 6 is the method of any of embodiments 1 to 5, wherein the second reaction conditions include a reaction pressure in the riser reactor of 1 to 3 bar. Embodiment 7 is the method of any of embodiments 1 to 5, wherein the second reaction conditions include an average residence time in the riser reactor of 0.4 to 2 s. Embodiment 8 is the method of any of embodiments 1 to 7, wherein the fast fluidized bed reactor is adapted to enable back mixing of the unreacted hydrocarbons of the naphtha, the first product, and the catalyst particles. Embodiment 9 is the method of any of embodiments 1 to 8, wherein the fast fluidized bed reactor is operated at a solid volumetric fraction in a range of 0.12 to 0.35 vol. %. Embodiment 10 is the method of any of embodiments 1 to 9, wherein the riser reactor is operated at a solid volumetric fraction in a range of 10 to 15 vol. %. Embodiment 11 is the method of any of embodiments 1 to 10, wherein the catalyst particles contain zeolite. Embodiment 12 is the method of any of embodiments 1 to 11, wherein the naphtha is introduced in the fast fluidized bed via a sparger. Embodiment 13 is the method of any of embodiments 1 to 12, wherein the flowing of the effluent of the fast fluidized bed reactor includes flowing a lift gas in the fast fluidized bed reactor through a lift gas sparger to carry the unreacted hydrocarbons of the naphtha, the first product, and the catalyst particles from the fast fluidized bed into the riser reactor. Embodiment 14 is the method of embodiment 13, wherein the lift gas is selected from the group consisting of nitrogen, methane, steam, any inert gas, and combinations thereof. Embodiment 15 is the method of either of embodiments 13 or 14, wherein the lift gas contains less than 10 wt. % steam.

Embodiment 16 is a reaction unit for producing aromatics. The reaction unit includes a fast fluidized bed reactor containing a housing, and a feed inlet adapted to receive hydrocarbon feed into the housing. The reaction unit further includes a catalyst inlet adapted to receive catalyst particles that are capable of catalyzing cracking of the hydrocarbon feed to produce aromatics into the housing. The reaction unit still further includes a lift gas inlet adapted to receive a lift gas into the housing. The reaction unit also includes a riser reactor located on top of the fast fluidized bed reactor, wherein the riser reactor is in fluid communication with the fast fluidized bed reactor such that content from the fast fluidized bed reactor flows into the riser reactor. Embodiment 17 is the reaction unit of embodiment 16, further including a product separation unit in fluid communication with top half of the riser reactor adapted to separate an effluent stream from the riser reactor into a product gas stream and a catalyst stream The reaction unit further includes a catalyst regenerator located at a lower half of the product separation unit adapted to receive the catalyst stream from the product separation unit and regenerate the catalyst, wherein an outlet of the catalyst regenerator is in fluid communication with the catalyst inlet of the fast fluidized bed reactor such that regenerated catalyst is fed from the catalyst regenerator to the fast fluidized bed reactor.

Embodiment 18 is a reaction system for producing aromatics. The reaction system includes two or more fast fluidized bed reactors of either of embodiments 16 or 17, two or more riser reactors of either of embodiments 16 or 17, a product separation unit of either of embodiments 16 or 17, and a catalyst regenerator of either of embodiments 16 or 17, wherein the product separation unit is in fluid communication with each of the two or more riser reactors such that effluent from each of the riser reactors flows into the product separation unit, and the catalyst regenerator is in fluid communication with the catalyst inlet of each of the two or more fluidized bed reactors such that regenerated catalyst is fed from the catalyst regenerator to the fast fluidized bed reactor.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing an aromatic, the method comprising:
contacting, in a fast fluidized bed reactor, naphtha with catalyst particles of a fast-fluidized bed having a superficial gas velocity (SGV) in a range of 1 to 6.5 m/s and under first reaction conditions sufficient to produce a first product comprising one or more aromatics;
flowing effluent of the fast fluidized bed reactor to a riser reactor, the effluent of the fast fluidized bed reactor comprising (1) unreacted hydrocarbons of the naphtha, (2) the first product, and (3) the catalyst particles; and
contacting, in the riser reactor, the unreacted hydrocarbons of the naphtha, the first product, and the at least some of the catalyst particles under second reaction conditions sufficient to produce a second product comprising one or more aromatics.

2. The method of claim 1, wherein the first reaction conditions include a reaction temperature in the fast fluidized bed reactor of 690 to 710° C.

3. The method of claim 1, wherein the first reaction conditions include a reaction pressure in the fast fluidized bed reactor of 1 to 3 bar.

4. The method of claim 1, wherein the first reaction conditions include an average residence time in the fast fluidized bed reactor of 1 to 15 s.

5. The method of claim 1, wherein the second reaction conditions include a reaction temperature in the riser reactor of 670 to 700° C.

6. The method of claim 1, wherein the second reaction conditions include a reaction pressure in the riser reactor of 1 to 3 bar.

7. The method of claim 1, wherein the second reaction conditions include an average residence time in the riser reactor of 0.4 to 2 s.

8. The method of claim 1, wherein the fast fluidized bed reactor is adapted to enable back mixing of the unreacted hydrocarbons of the naphtha, the first product, and the catalyst particles.

9. The method of claim 1, wherein the fast fluidized bed reactor is operated at a solid volumetric fraction in a range of 0.12 to 0.35 vol. %.

10. The method of claim 1, wherein the riser reactor is operated at a solid volumetric fraction in a range of 10 to 15 vol. %.

11. The method of claim 1, wherein the catalyst particles comprise zeolite.

12. The method of claim 1, wherein the naphtha is introduced in the fast fluidized bed via a sparger.

13. The method of claim 1, wherein the flowing of the effluent of the fast fluidized bed reactor comprises flowing a lift gas in the fast fluidized bed reactor through a lift gas sparger to carry the unreacted hydrocarbons of the naphtha, the first product, and the catalyst particles from the fast fluidized bed into the riser reactor.

14. The method of claim 13, wherein the lift gas is selected from the group consisting of nitrogen, methane, steam, any inert gas, and combinations thereof.

15. The method of claim 13, wherein the lift gas contains less than 10 wt. % steam.

16. A reaction unit for producing aromatics, the reaction unit comprising:
a fast fluidized bed reactor comprising:
a housing;
a feed inlet adapted to receive hydrocarbon feed into the housing;
a catalyst inlet adapted to receive catalyst particles that are capable of catalyzing cracking of the hydrocarbon feed to produce aromatics into the housing; and
a lift gas inlet adapted to receive a lift gas into the housing; and
a riser reactor disposed on top of the fast fluidized bed reactor, wherein the riser reactor is in fluid communication with the fast fluidized bed reactor such that content from the fast fluidized bed reactor flows into the riser reactor.

17. The reaction unit of claim 16, further comprising:
a product separation unit in fluid communication with top half of the riser reactor adapted to separate an effluent stream from the riser reactor into a product gas stream and a catalyst stream; and
a catalyst regenerator disposed at a lower half of the product separation unit adapted to receive the catalyst stream from the product separation unit and regenerate the catalyst, wherein an outlet of the catalyst regenerator is in fluid communication with the catalyst inlet of the fast fluidized bed reactor such that regenerated catalyst is fed from the catalyst regenerator to the fast fluidized bed reactor.

18. A reaction system for producing aromatics, the reaction system comprising:
two or more fast fluidized bed reactors of claim 16;
two or more riser reactors of claim 16;
a product separation unit of claim 16;
a catalyst regenerator of claim 16;
wherein the product separation unit is in fluid communication with each of the two or more riser reactors such that effluent from each of the riser reactors flows into the product separation unit, and the catalyst regenerator is in fluid communication with the catalyst inlet of each of the two or more fluidized bed reactors such that regenerated catalyst is fed from the catalyst regenerator to the fast fluidized bed reactor.

19. The method of claim 3, wherein the naphtha is introduced in the fast fluidized bed via a sparger.

20. The method of claim 4, wherein the naphtha is introduced in the fast fluidized bed via a sparger.
